(19) United States
(12) Patent Application Publication
(10) Pub. No.: US 2014/0234619 A1
(43) Pub. Date: Aug. 21, 2014

(54) POLY(ARYLENE ETHER) COMPOSITION AND ARTICLES DERIVED THEREFROM

(71) Applicant: Wei Shan, Shanghai (CN)

(72) Inventor: Wei Shan, Shanghai (CN)

(21) Appl. No.: 13/515,510

(22) PCT Filed: Jul. 22, 2011
(86) PCT No.: PCT/CN11/77466

§ 371 Date: Apr. 29, 2014

(51) Int. Cl. H01B 3/42; H01B 3/30; H01B 3/44

(52) U.S. Cl. CPC H01B 3/427; H01B 3/442; H01B 3/441; H01B 3/307
USPC 428/366; 524/101

(57) ABSTRACT

A composition useful for forming wire and cable insulation includes particular amounts of a poly(arylene ether), a hydrogenated block copolymer of an alkenyl aromatic compound and a conjugated diene, a polyolefin, and a flame retardant. The flame retardant includes specific amounts of zinc borate, melamine cyanurate, and an organophosphate ester. The composition provides reduced cost and increased flexibility relative to known compositions using melamine polyphosphate and metal phosphinate flame retardants.

### BACKGROUND OF THE INVENTION

Poly(arylene ether) is a type of plastic known for its excellent water resistance, dimensional stability, and inherent flame retardancy. Properties such as impact strength, stiffness, chemical resistance, and heat resistance can be tailored by blending poly(arylene ether) with various other plastics in order to meet the requirements of a wide variety of consumer products, for example, plumbing fixtures, electrical boxes, automotive parts, and insulation for wire and cable.

A different plastic, poly(vinyl chloride), is currently the commercially dominant material for flame retardant wire and cable insulation. However, poly(vinyl chloride) is a halogenated material. There is mounting concern over the environmental impact of halogenated materials, and non-halogenated alternatives are being sought. Furthermore, there are environmental concerns associated with the typical use of phthalates as plasticizers and heavy metal salts as heat stabilizers in PVC compositions. There is therefore a strong desire—and in some places a legislative mandate—to replace poly(vinyl chloride) with non-halogenated polymer compositions.

Recent research has demonstrated that certain halogen-free poly(arylene ether) compositions can possess the physical and flame retardant properties needed for use as wire and cable insulation. See, for example, U.S. Patent Application Publication Nos. US 2006/0106139 A1 and US 2006/0182967 A1 of Kosaka et al., and U.S. Patent Application Publication No. US 2010/0139944 A1 of Guo et al. The compositions disclosed in these references can exhibit good flame retardancy and good physical properties such as flexibility and tensile stress at break. In one approach to halogen-free poly(arylene ether) compositions, substantial amounts of other flame retardants are added to assure that the compositions as a whole are sufficiently flame retardant. Trade-offs in physical properties typically accompany the relatively large amounts of flame retardants required. For example, when the flame retardant comprises substantial amounts of a metal hydroxide such as magnesium dihydroxide, flexibility is compromised. In another approach to halogen-free poly(arylene ether) compositions, a reduced amount of flame retardant is used, but these compositions typically require one or more relatively expensive flame retardants, such as a melamine polyphosphate (see, for example, U.S. Pat. No. 7,417,083 to Kosaka et al.) or a metal phosphinate (see, for example, U.S. Pat. No. 7,608,651 B2 to Borade et al.; and U.S. Pat. Nos. 7,589,281 B2, 7,622,522, and 7,655,714 to Qiu et al.). There remains a desire for reduced-cost flame retardant poly(arylene ether) compositions that exhibit the flame retardancy required for wire and cable insulation while maintaining or improving physical properties.

### BRIEF DESCRIPTION OF EMBODIMENTS OF THE INVENTION

One embodiment is a composition comprising: about 21 to about 40 weight percent of a poly(arylene ether); about 20 to about 45 weight percent of a hydrogenated block copolymer of an alkenyl aromatic compound and a conjugated diene; about 2 to about 20 weight percent of a polyolefin; and about 11 to about 35 weight percent of a flame retardant comprising about 1 to about 10 weight percent of zinc borate, about 5 to about 20 weight percent of melamine cyanurate, and about 2 to about 15 weight percent of an organophosphate ester, wherein all weight percents are based on the total weight of the composition, unless a different weight basis is specified.

Another embodiment is a composition comprising the product of melt blending components comprising: about 21 to about 40 weight percent of a poly(arylene ether); about 20 to about 45 weight percent of a hydrogenated block copolymer of an alkenyl aromatic compound and a conjugated diene; about 2 to about 20 weight percent of a polyolefin; and about 11 to about 35 weight percent of a flame retardant comprising about 1 to about 10 weight percent of zinc borate, about 5 to about 20 weight percent of melamine cyanurate, and about 2 to about 15 weight percent of an organophosphate ester; wherein all weight percents are based on the total weight of the composition, unless a different weight basis is specified.

Another embodiment is an extrusion molded article or injection molded article comprising the product of extrusion molding or injection molding any of the compositions described herein.

These and other embodiments are described in detail below.

### BRIEF DESCRIPTION OF THE DRAWINGS

FIG. 1 is a chemical scheme for the preparation of a poly(arylene ether) by oxidative polymerization of 2,6-dimethylphenol to yield poly(2,6-dimethyl-1,4-phenylene ether) and 3,3′,5,5′-tetramethyldiphenoquinone; reequilibration of the reaction mixture can produce a poly(arylene ether) with terminal and internal residues of incorporated diphenoquinone.

### DETAILED DESCRIPTION OF THE INVENTION

The present inventors have determined that flame retardant poly(arylene ether) compositions suitable for use as insulating materials for wire and cable can be obtained using specific amounts of three flame retardants: zinc borate, melamine cyanurate, and organophosphate ester. It has also been surprisingly determined that even relatively small amounts of zinc borate impart improved flexibility to the compositions. Thus, it has been possible to prepare poly(arylene ether) compositions that maintain adequate flame retardancy and improve flexibility while reducing cost.

One embodiment is a composition comprising: about 21 to about 40 weight percent of a poly(arylene ether); about 20 to about 45 weight percent of a hydrogenated block copolymer of an alkenyl aromatic compound and a conjugated diene; about 2 to about 20 weight percent of a polyolefin; and about 11 to about 35 weight percent of a flame retardant comprising about 1 to about 10 weight percent of zinc borate, about 5 to about 20 weight percent of melamine cyanurate, and about 2 to about 15 weight percent of an organophosphate ester; wherein all weight percents are based on the total weight of the composition, unless a different weight basis is specified.

The composition comprises a poly(arylene ether). Suitable poly(arylene ether)s include those comprising repeating structural units having the formula

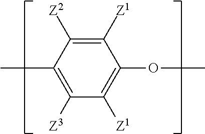

wherein each occurrence of Z¹ is independently halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₂ halohydrocarbyloxy wherein at least two carbon atoms separate the halogen and oxygen atoms; and each occurrence of Z² is independently hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms. As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. As one example, Z¹ can be a di-n-butylaminomethyl group formed by reaction of a terminal 3,5-dimethyl-1,4-phenyl group with the di-n-butylamine component of an oxidative polymerization catalyst.

In some embodiments, the poly(arylene ether) has an intrinsic viscosity of about 0.25 to about 1 deciliter per gram measured at 25° C. in chloroform. Within this range, the poly(arylene ether) intrinsic viscosity can be about 0.3 to about 0.65 deciliter per gram, more specifically about 0.35 to about 0.5 deciliter per gram, even more specifically about 0.4 to about 0.5 deciliter per gram.

In some embodiments, the poly(arylene ether) is a poly(2,6-dimethyl-1,4-phenylene ether) prepared with a morpholine-containing catalyst, wherein a purified sample of poly(2,6-dimethyl-1,4-phenylene ether) prepared by dissolution of the poly(2,6-dimethyl-1,4-phenylene ether) in toluene, precipitation from methanol, reslurry, and isolation has a monomodal molecular weight distribution in the molecular weight range of 250 to 1,000,000 atomic mass units, and comprises less than or equal to 2.2 weight percent of poly(2,6-dimethyl-1,4-phenylene ether) having a molecular weight more than fifteen times the number average molecular weight of the entire purified sample. In some embodiments, the purified sample after separation into six equal poly(2,6-dimethyl-1,4-phenylene ether) weight fractions of decreasing molecular weight comprises a first, highest molecular weight fraction comprising at least 10 mole percent of poly(2,6-dimethyl-1,4-phenylene ether) comprising a terminal morpholine-substituted phenoxy group. The poly(2,6-dimethyl-1,4-phenylene ether) according to these embodiments is further described in U.S. Patent Application Publication No. US 2011/0003962 A1 of Carrillo et al.

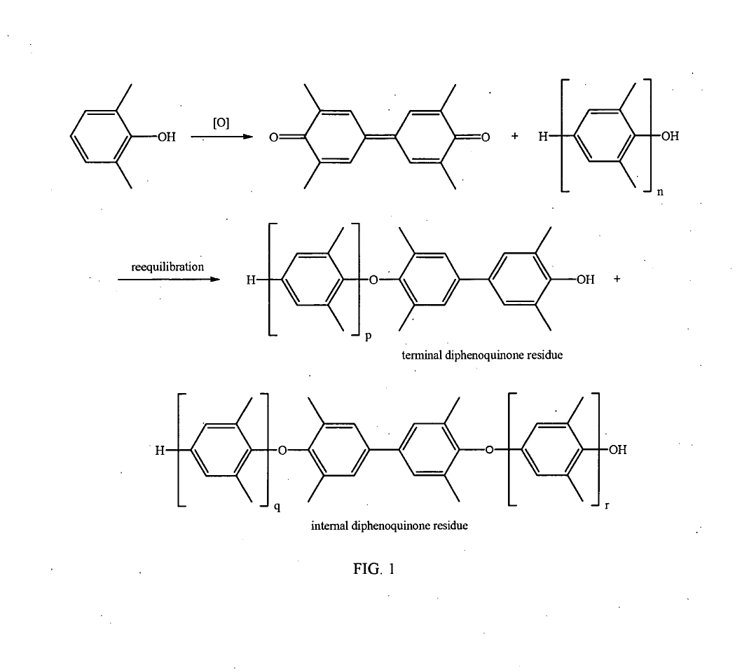

In some embodiments, the poly(arylene ether) is essentially free of incorporated diphenoquinone residues. In the context, “essentially free” means that the fewer than 1 weight percent of poly(arylene ether) molecules comprise the residue of a diphenoquinone. As described in U.S. Pat. No. 3,306,874 to Hay, synthesis of poly(arylene ether) by oxidative polymerization of monohydric phenol yields not only the desired poly(arylene ether) but also a diphenoquinone as side product. For example, when the monohydric phenol is 2,6-dimethylphenol, 3,3′,5,5′-tetramethyldiphenoquinone is generated. Typically, the diphenoquinone is “reequilibrated” into the poly(arylene ether) (i.e., the diphenoquinone is incorporated into the poly(arylene ether) structure) by heating the polymerization reaction mixture to yield a poly(arylene ether) comprising terminal or internal diphenoquinone residues. For example, as shown in FIG. 1, when a poly(arylene ether) is prepared by oxidative polymerization of 2,6-dimethylphenol to yield poly(2,6-dimethyl-1,4-phenylene ether) and 3,3′,5,5′-tetramethyldiphenoquinone, reequilibration of the reaction mixture can produce a poly(arylene ether) with terminal and internal residues of incorporated diphenoquinone. However, such reequilibration reduces the molecular weight of the poly(arylene ether) (e.g., p and q+r are less than n). Accordingly, when a higher molecular weight poly(arylene ether) is desired, it may be desirable to separate the diphenoquinone from the poly(arylene ether) rather than reequilibrating the diphenoquinone into the poly(arylene ether) chains. Such a separation can be achieved, for example, by precipitation of the poly(arylene ether) in a solvent or solvent mixture in which the poly(arylene ether) is insoluble and the diphenoquinone is soluble. For example, when a poly(arylene ether) is prepared by oxidative polymerization of 2,6-dimethylphenol in toluene to yield a toluene solution comprising poly(2,6-dimethyl-1,4-phenylene ether) and 3,3′,5,5′-tetramethyldiphenoquinone, a poly(2,6-dimethyl-1,4-phenylene ether) essentially free of diphenoquinone can be obtained by mixing 1 volume of the toluene solution with about 1 to about 4 volumes of methanol or a methanol/water mixture. Alternatively, the amount of diphenoquinone side-product generated during oxidative polymerization can be minimized (e.g., by initiating oxidative polymerization in the presence of less than 10 weight percent of the monohydric phenol and adding at least 95 weight percent of the monohydric phenol over the course of at least 50 minutes), and/or the reequilibration of the diphenoquinone into the poly(arylene ether) chain can be minimized (e.g., by isolating the poly(arylene ether) no more than 200 minutes after termination of oxidative polymerization). These approaches are described in International Patent Application Publication No. WO2009/104107 A1 of Delsman et al. In an alternative approach utilizing the temperature-dependent solubility of diphenoquinone in toluene, a toluene solution containing diphenoquinone and poly(arylene ether) can be adjusted to a temperature of about 25° C., at which diphenoquinone is poorly soluble but the poly(arylene ether) is soluble, and the insoluble diphenoquinone can be removed by solid-liquid separation (e.g., filtration).

In some embodiments, the poly(arylene ether) comprises 2,6-dimethyl-1,4-phenylene ether units, 2,3,6-trimethyl-1,4-phenylene ether units, or a combination thereof. In some embodiments, the poly(arylene ether) is a poly(2,6-dimethyl-1,4-phenylene ether). In some embodiments, the poly(arylene ether) comprises a poly(2,6-dimethyl-1,4-phenylene ether) having an intrinsic viscosity of about 0.35 to about 0.6 deciliter per gram, specifically about 0.4 to about 0.5 deciliter per gram, measured at 25° C. in chloroform.

The poly(arylene ether) can comprise molecules having aminoalkyl-containing end group(s), typically located in a position ortho to the hydroxy group. Also frequently present are tetramethyldiphenoquinone (TMDQ) end groups, typically obtained from 2,6-dimethylphenol-containing reaction mixtures in which tetramethyldiphenoquinone by-product is present. The poly(arylene ether) can be in the form of a homopolymer, a copolymer, a graft copolymer, an ionomer, or a block copolymer, as well as combinations comprising at least one of the foregoing.

The composition comprises the poly(arylene ether) in an amount of about 21 to about 40 weight percent, based on the total weight of the composition. Within this range, the poly(arylene ether) amount can be about 22 to about 30 weight percent, more specifically about 25 to about 30 weight percent.

In addition to the poly(arylene ether), the composition comprises a hydrogenated block copolymer of an alkenyl aromatic compound and a conjugated diene. For brevity, this component is referred to as the “hydrogenated block copolymer”. The hydrogenated block copolymer can comprise about 10 to about 90 weight percent of poly(alkenyl aromatic) content and about 90 to about 10 weight percent of hydrogenated poly(conjugated diene) content, based on the weight of the hydrogenated block copolymer. In some embodiments, the hydrogenated block copolymer is a low poly(alkenyl aromatic content) hydrogenated block copolymer in which the poly(alkenyl aromatic) content is about 10 to less than 40 weight percent, specifically about 20 to about 35 weight percent, more specifically about 25 to about 35 weight percent, yet more specifically about 30 to about 35 weight percent, all based on the weight of the low poly(alkenyl aromatic content) hydrogenated block copolymer.

In some embodiments, the hydrogenated block copolymer has a weight average molecular weight of about 40,000 to about 400,000 atomic mass units. The number average molecular weight and the weight average molecular weight can be determined by gel permeation chromatography and based on comparison to polystyrene standards. In some embodiments, the hydrogenated block copolymer has a weight average molecular weight of about 100,000 to about 200,000 atomic mass units, specifically about 150,000 to about 200,000 atomic mass units. In other embodiments, the hydrogenated block copolymer has a weight average molecular weight of about 200,000 to about 400,000 atomic mass units, specifically about 250,000 to about 400,000 atomic mass units. It is specifically contemplated to use a mixture of two or more hydrogenated block copolymers in which at least one hydrogenated block copolymer has a weight average molecular weight of about 150,000 to about 200,000 atomic mass units, and at least one hydrogenated block copolymer has a weight average molecular weight of about 250,000 to about 400,000 atomic mass units.

The alkenyl aromatic monomer used to prepare the hydrogenated block copolymer can have the structure

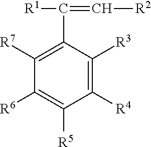

wherein R¹ and R² each independently represent a hydrogen atom, a C₁-C₈ alkyl group, or a C₂-C₈ alkenyl group; R³ and R⁷ each independently represent a hydrogen atom, a C₁-C₈ alkyl group, a chlorine atom, or a bromine atom; and R⁴, R⁵ and R⁶ each independently represent a hydrogen atom, a C₁-C₈ alkyl group, or a C₂-C₈ alkenyl group, or R⁵ and R⁶ are taken together with the central aromatic ring to form a naphthyl group, or R⁵ and R⁶ are taken together with the central aromatic ring to form a naphthyl group. Specific alkenyl aromatic monomers include, for example, styrene, chlorostyrenes such as p-chlorostyrene, methylstyrenes such as alpha-methylstyrene and p-methylstyrene, and t-butylstyrenes such as 3-t-butylstyrene and 4-t-butylstyrene. In some embodiments, the alkenyl aromatic monomer is styrene.

The conjugated diene used to prepare the hydrogenated block copolymer can be a C₄-C₂₀ conjugated diene. Suitable conjugated dienes include, for example, 1,3-butadiene, 2-methyl-1,3-butadiene, 2-chloro-1,3-butadiene, 2,3-dimethyl-1,3-butadiene, 1,3-pentadiene, 1,3-hexadiene, and the like, and combinations thereof. In some embodiments, the conjugated diene is 1,3-butadiene, 2-methyl-1,3-butadiene, or a combination thereof. In some embodiments, the conjugated diene consists of 1,3-butadiene.

The hydrogenated block copolymer is a copolymer comprising (A) at least one block derived from an alkenyl aromatic compound and (B) at least one block derived from a conjugated diene, in which the aliphatic unsaturated group content in the block (B) is at least partially reduced by hydrogenation. In some embodiments, the aliphatic unsaturation in the (B) block is reduced by at least 50 percent, specifically at least 70 percent. The arrangement of blocks (A) and (B) includes a linear structure, a grafted structure, and a radial teleblock structure with or without a branched chain. Linear block copolymers include tapered linear structures and non-tapered linear structures. In some embodiments, the hydrogenated block copolymer has a tapered linear structure. In some embodiments, the hydrogenated block copolymer has a non-tapered linear structure. In some embodiments, the hydrogenated block copolymer comprises a (B) block that comprises random incorporation of alkenyl aromatic monomer. Linear block copolymer structures include diblock (A-B block), triblock (A-B-A block or B-A-B block), tetrablock (A-B-A-B block), and pentablock (A-B-A-B-A block or B-A-B-A-B block) structures as well as linear structures containing 6 or more blocks in total of (A) and (B), wherein the molecular weight of each (A) block can be the same as or different from that of other (A) blocks, and the molecular weight of each (B) block can be the same as or different from that of other (B) blocks. In some embodiments, the hydrogenated block copolymer is a diblock copolymer, a triblock copolymer, or a combination thereof.

In some embodiments, the hydrogenated block copolymer excludes the residue of monomers other than the alkenyl aromatic compound and the conjugated diene. In some embodiments, the hydrogenated block copolymer consists of blocks derived from the alkenyl aromatic compound and the conjugated diene. It does not comprise grafts formed from these or any other monomers. It also consists of carbon and hydrogen atoms and therefore excludes heteroatoms. In some embodiments, the hydrogenated block copolymer includes the residue of one or more acid functionalizing agents, such as maleic anhydride. In some embodiments, the hydrogenated block copolymer comprises a polystyrene-poly(ethylene-butylene)-polystyrene triblock copolymer.

Methods for preparing hydrogenated block copolymers are known in the art and many hydrogenated block copolymers are commercially available. Illustrative commercially available hydrogenated block copolymers include the polystyrene-poly(ethylene-propylene) diblock copolymers available from Kraton Polymers as KRATON G1701 and G1702; the polystyrene-poly(ethylene-butylene)-polystyrene triblock copolymers available from Kraton Polymers as KRATON G1641, G1650, G1651, G1654, G1657, G1726, G4609, G4610, GRP-6598, RP-6924, MD-6932M, MD-6933, and MD-6939; the polystyrene-poly(ethylene-butylene-styrene)-polystyrene (S-EB/S-S) triblock copolymers available from Kraton Polymers as KRATON RP-6935 and RP-6936, the polystyrene-poly(ethylene-propylene)-polystyrene triblock copolymers available from Kraton Polymers as KRATON G1730; the maleic anhydride-grafted polystyrene-poly(ethylene-butylene)-polystyrene triblock copolymers available from Kraton Polymers as KRATON G1901, G1924, and MD-6684; the maleic anhydride-grafted polystyrene-poly(ethylene-butylene-styrene)-polystyrene triblock copolyer available from Kraton Polymers as KRATON MD-6670; the polystyrene-poly(ethylene-butylene)-polystyrene triblock copolymer comprising 67 weight percent polystyrene available from Asahi Kasei Elastomer as TUFTEC H1043; the polystyrene-poly(ethylene-butylene)-polystyrene triblock copolymer comprising 42 weight percent polystyrene available from Asahi Kasei Elastomer as TUFTEC H1051; the polystyrene-poly(butadiene-butylene)-polystyrene triblock copolymers available from Asahi Kasei Elastomer as TUFTEC P1000 and P2000; the polystyrene-poly(ethylene-butylene)-polystyrene triblock copolymer comprising 60 weight polystyrene available from Kuraray as SEPTON S8104; the polystyrene-poly(ethylene-ethylene/propylene)-polystyrene triblock copolymers available from Kuraray as SEPTON S4044, S4055, S4077, and S4099; and the polystyrene-poly(ethylene-propylene)-polystyrene triblock copolymer comprising 65 weight percent polystyrene available from Kuraray as SEPTON S2104. Mixtures of two of more hydrogenated block copolymers can be used.

The composition comprises a hydrogenated block copolymer in an amount of about 20 to about 45 weight percent, specifically about 22 to about 40 weight percent, more specifically about 26 to about 36 weight percent, based on the total weight of the composition.

In addition to the poly(arylene ether) and the hydrogenated block copolymer, the composition comprises a polyolefin. Polyolefins include polyethylenes (including high density polyethylene (HDPE), low density polyethylene (LDPE), medium density polyethylene (MDPE), and linear low density polyethylene (LLDPE)), polypropylenes (including atactic, syndiotactic, and isotactic polypropylenes), and polyisobutylenes. Polyolefins and methods for their preparation are known in the art and are described for example in U.S. Pat. No. 2,933,480 to Gresham et al., U.S. Pat. No. 3,093,621 to Gladding, U.S. Pat. No. 3,211,709 to Adamek et al., U.S. Pat. No. 3,646,168 to Barrett, U.S. Pat. No. 3,790,519 to Wahlborg, U.S. Pat. No. 3,884,993 to Gros, U.S. Pat. No. 3,894,999 to Boozer et al., and U.S. Pat. No. 4,059,654 to von Bodungen. The density of polyethylene (HDPE, LDPE, MDPE, LLDPE) can be 0.90 gram/cm³ to 0.98 gram/cm³. Polyolefins include ethylene/alpha-olefin copolymers, such as copolymers of ethylene and 1-butene, copolymers of ethylene and 1-hexene, and copolymers of ethylene and 1-octene. Additionally, copolymers of olefins can also be used, such as copolymers of polypropylene with rubber and polyethylene with rubber. Copolymers of polypropylene and rubber are sometimes referred to as impact modified polypropylene. Such copolymers are typically heterophasic and have sufficiently long sections of each component to have both amorphous and crystalline phases. In some embodiments the polyolefin comprises a polyolefin block copolymer comprising an end group consisting essentially of a polyolefin homopolymer of C₂ to C₃ olefins and a middle block comprising a copolymer of C₂ to C₁₂ olefins. Additionally the polyolefin can comprise a combination of homopolymer and copolymer, a combination of homopolymers having different melt temperatures, and/or a combination of homopolymers having a different melt flow rate. In some embodiments, the polyolefin has a melt flow rate (MFR) of about 0.3 to about 10 grams per ten minutes (g/10 min). Specifically, the melt flow rate can be about 0.3 to about 5 grams per ten minutes. Melt flow rate can be determined according to ASTM D1238-10 using either powdered or pelletized polyolefin, a load of 2.16 kilograms and a temperature suitable for the polyolefin (190° C. for ethylene-based polyolefins and 230° C. for propylene-based polyolefins). In some embodiments, the polyolefin comprises homopolyethylene or a polyethylene copolymer. Additionally the polyethylene can comprise a combination of homopolymer and copolymer, a combination of homopolymers having different melting temperatures, and/or a combination of homopolymers having different melt flow rates.

In some embodiments, the polyolefin comprises polyisobutylene. In some embodiments, the polyolefin comprises polypropylene and polyisobutylene. In some embodiments, the polyolefin consists of polypropylene and polyisobutylene. In some embodiments, the polyolefin excludes ethylene homopolymers.

The composition comprises the polyolefin in an amount of about 2 to about 20 weight percent, specifically about 5 to about 15 weight percent, more specifically about 11 to about 16 weight percent, based on the total weight of the composition.

In addition to the poly(arylene ether), the hydrogenated block copolymer, and the polyolefin, the composition comprises a flame retardant comprising zinc borate, melamine cyanurate, and an organophosphate ester. The present inventors have determined that this particular combination of flame retardants, each in a specific amount, provides the flame retardancy needed for wire and cable insulation as well as increased flexibility and reduced cost relative to other halogen-free insulation compositions.

The flame retardant as a whole is present in an amount of about 11 to about 35 weight percent, based on the total weight of the composition. Within this range, the flame retardant amount can be about 15 to about 30 weight percent, specifically about 18 to about 27 weight percent.

The flame retardant comprises zinc borate. The term “zinc borate” refers to a borate of zinc and includes stoichiometric variations such as 2ZnO.3B₂O₃.3.5H₂O (CAS Reg. No. 138265-88-0), 2ZnO.3B₂O₃ (CAS Reg. No. 138265-88-0), 4ZnO.B₂O₃.H₂O (CAS Reg. No. 149749-62-2), 4ZnO.6B₂O₃.7H₂O (CAS number 1332-07-6), and 2ZnO.2B₂O₃.3H₂O (CAS number 1332-07-6). Commercially-available zinc borates include FIREBRAKE ZB, FIREBRAKE 415, and FIREBRAKE 500, all from U.S. Borax Inc.; and ZB-223 and ZB-467 from Chemtura.

The composition comprises the zinc borate in an amount of about 1 to about 10 weight percent, based on the total weight of the composition. Within this range, the zinc borate amount can be about 2 to about 9 weight percent, specifically about 3 to about 8 weight percent.

The flame retardant also comprises melamine cyanurate. Melamine cyanurate, CAS Reg. No. 37640-57-6, is a 1:1 complex of melamine and cyanuric acid. It is commercially available from a variety of suppliers. The composition comprises the melamine cyanurate in an amount of about 5 to about 20 weight percent, based on the total weight of the composition. Within this range, the melamine cyanurate amount can be about 5 to about 15 weight percent, specifically about 6 to about 13 weight percent.

The flame retardant also comprises an organophosphate ester. Exemplary organophosphate ester flame retardants include phosphate esters comprising phenyl groups, substituted phenyl groups, or a combination of phenyl groups and substituted phenyl groups, bis-aryl phosphate esters based upon resorcinol such as, for example, resorcinol bis(diphenyl phosphate), as well as those based upon bisphenols such as, for example, bisphenol A bis(diphenyl phosphate). In some embodiments, the organophosphate ester is selected from tris(alkylphenyl)phosphates (for example, CAS Reg. No. 89492-23-9 or CAS Reg. No. 78-33-1), resorcinol bis(diphenyl phosphate) (CAS Reg. No. 57583-54-7), bisphenol A bis(diphenyl phosphate) (CAS Reg. No. 181028-79-5), triphenyl phosphate (CAS Reg. No. 115-86-6), tris(isopropylphenyl)phosphates (for example, CAS Reg. No. 68937-41-7), and mixtures thereof.

In some embodiments the organophosphate ester comprises a bis-aryl phosphate having the formula

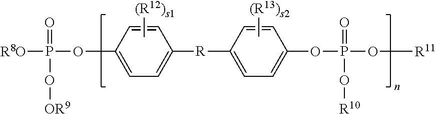

wherein R is independently at each occurrence a C₁-C₁₂ alkylene group; R¹² and R¹³ are independently at each occurrence a C₁-C₅ alkyl group; R⁸, R⁹, and R¹¹ are independently a C₁-C₁₂ hydrocarbyl group; R¹⁰ is independently at each occurrence a C₁-C₁₂ hydrocarbyl group; n is 1 to 25; and s1 and s2 are independently an integer equal to 0, 1, or 2. In some embodiments OR⁸, OR⁹, OR¹⁰ and OR¹¹ are independently derived from phenol, a monoalkylphenol, a dialkylphenol, or a trialkylphenol.

As readily appreciated by one of ordinary skill in the art, the bis-aryl phosphate is derived from a bisphenol. Exemplary bisphenols include 2,2-bis(4-hydroxyphenyl)propane (so-called bisphenol A), 2,2-bis(4-hydroxy-3-methylphenyl)propane, bis(4-hydroxyphenyl)methane, bis(4-hydroxy-3,5-dimethylphenyl)methane and 1,1-bis(4-hydroxyphenyl)ethane. In some embodiments, the bisphenol comprises bisphenol A. In some embodiments, the organophosphate ester comprises bisphenol A bis(diphenyl phosphate).

The composition comprises the organophosphate ester in an amount of about 2 to about 15 weight percent, based on the total weight of the composition. Within this range, the organophosphate ester amount can be about 4 to about 15 weight percent, specifically about 7 to about 13 weight percent.

As the three required flame retardants are sufficient to provide the desired properties, it is possible to omit other flame retardants. For example, in some embodiments the composition excludes boron phosphate. As another example, in some embodiments the composition excludes metal hydroxides such as magnesium dihydroxide. As yet another example, in some embodiments, the composition excludes phosphinate flame retardants, including metal dialkyl phosphinates such as aluminum tris(diethyl phosphinate). As still another example, in some embodiments the composition excludes phosphate flame retardants other than the organophosphate ester. These other phosphate flame retardants that can, optionally, be excluded from the composition include melamine phosphate, melamine pyrophosphate, melamine polyphosphate, melamine orthophosphate, monoammonium phosphate, diammonium phosphate, phosphoric acid amide, ammonium polyphosphate, and polyphosphoric acid amide. In some embodiments, the thermoplastic composition excludes any flame retardant not described herein as required.

In some embodiments, the composition comprises about 3 to about 10 weight percent of mineral oil.

The composition can, optionally, further comprise various additives known in the thermoplastics art. For example, the thermoplastic composition may, optionally, further comprise an additive chosen from stabilizers, mold release agents, processing aids, drip retardants, nucleating agents, UV blockers, dyes, pigments, antioxidants, anti-static agents, blowing agents, metal deactivators, antiblocking agents, nanoclays, and the like, and combinations thereof. When present, additives are typically used in a total amount less than about 5 weight percent, specifically less than 3 weight percent, based on the total weight of the composition.

The composition can, optionally, exclude any polymer not described herein as required or optional. For example, the composition can, optionally, exclude one or more of homopolystyrenes, rubber-modified polystyrenes, unhydrogenated block copolymers of alkenyl aromatic compounds and conjugated dienes, polyamides, and polyesters.

In some embodiments, the composition excludes fillers.

In some embodiments, the composition is essentially halogen-free, by which it is meant that the composition comprises less than or equal to 0.5 weight percent of halogens. In some embodiments, the composition comprises less than 0.1 weight percent of halogens.

In a very specific embodiment of the composition, the poly(arylene ether) comprises a poly(2,6-dimethyl-1,4-phenylene ether) having an intrinsic viscosity of about 0.35 to about 0.5 deciliters per gram, measured at 25° C. in chloroform; the composition comprises about 22 to about 30 weight percent of the poly(arylene ether); the hydrogenated block copolymer comprises a polystyrene-poly(ethylene/butylene)-polystyrene triblock copolymer; the composition comprises about 26 to about 36 weight percent of the hydrogenated block copolymer; the polyolefin comprises polypropylene and polyisobutylene; the composition comprises about 11 to about 16 weight percent of the polyolefin; the flame retardant comprises about 2 to about 9 weight percent of zinc borate, about 5 to about 15 weight percent of melamine cyanurate, and about 4 to about 15 weight percent of an organophosphate ester; and the composition further comprises about 3 to about 10 weight percent of mineral oil.

The composition can also be described in product-by-process terms. For example, one embodiment is a composition comprising the product of melt blending components comprising about 21 to about 40 weight percent of a poly(arylene ether); about 20 to about 45 weight percent of a hydrogenated block copolymer of an alkenyl aromatic compound and a conjugated diene; about 2 to about 20 weight percent of a polyolefin; and about 11 to about 35 weight percent of a flame retardant comprising about 1 to about 10 weight percent of zinc borate, about 5 to about 20 weight percent of melamine cyanurate, and about 2 to about 15 weight percent of an organophosphate ester, wherein all weight percents are based on the total weight of the composition, unless a different weight basis is specified. All of the compositional variations described above apply as well to the product-by-process composition.

The composition can be prepared by melt-blending or melt-kneading the individual components together. The blending or kneading can be done using common equipment such as ribbon blenders, Henschel mixers, Banbury mixers, drum tumblers, single-screw extruders, twin-screw extruders, multi-screw extruders, co-kneaders, and the like. For example, the present composition can be prepared by melt-blending the components in a twin-screw extruder at a temperature of about 220 to about 270° C., specifically about 240 to about 260° C.

Although the invention has been described primarily in terms of a specific poly(arylene ether) composition, the flame retardant can be used with a wide variety of polymers. Thus, one embodiment is a composition comprising: a polymer; and a flame retardant mixture comprising zinc borate, melamine cyanurate, and an organophosphate ester. A wide variety of polymers can be used, including thermoplastics, thermoplastic elastomers, elastomers, and thermosets. Thermoplastics include polycarbonates, polyester (such as poly(ethylene terephthalate) and poly(butylene terephthalate), polyamides, polyimides, polyetherimides, polyurethanes, polystyrenes, poly(phenylene ether)s, poly(phenylene sulfide)s, polyarylsulfones, polyethersulfones, poly(ether ketone)s, polyacrylates (including poly(methyl methacrylate) and poly(butyl acrylate)), poly(vinyl butyral), polyethylenes, polypropylenes, poly(vinyl acetate), polyacrylonitriles, poly(vinyl chloride), poly(vinyl fluoride), poly(vinylidene fluoride), polytetrafluoroethylenes, copolymers of vinylidene chloride and vinyl chloride, copolymers of vinyl acetate and vinylidene chloride, copolymers of styrene and acrylonitrile, and the like, and combinations thereof. Thermoplastic elastomers include styrenic block copolymers, polyolefin blends, elastomeric alloys (including thermoplastic vulcanizates), thermoplastic polyurethanes, thermoplastic copolyesters, and the like, and combinations thereof. Elastomers include natural rubber, polybutadienes, polyisoprenes, copolymers of isobutylene and isoprene, copolymers of styrene and butadiene (styrene-butadiene rubber), copolymers of polybutadiene and acrylonitrile), polychloroprenes, copolymers of ethylene and propylene (ethylene-propylene rubber), polysiloxanes, fluorosilicone rubbers, polyether block amides, copolymers of ethylene and vinyl acetate, and the like, and combinations thereof. Thermosets include epoxy resins, cyanate ester resins, maleimide resins, benzoxazine resins, vinylbenzyl ether resins, alkene- or alkyne containing monomers, arylcyclobutene resins, perfluorovinyl ether resins, and oligomers and polymers with curable vinyl functionality, and combinations thereof. In some embodiments, the polymer is selected from the group consisting of polyesters, melamines, poly(vinyl chloride)s, polystyrenes, polyethylenes, chlorinated polyethylenes, polytetrachloroethylenes, polypropylenes, polycarbonates, polyimides, polyetherimides, poly(ether ether ketone)s, polysulfones, poly(arylene ether)s, polyamides, copolymers of styrene and acrylonitrile, copolymers of alpha-methylstyrene and acrylonitrile, copolymers of acrylonitrile and butadiene and styrene, copolymers of acrylonitrile and styrene and acrylate esters, polyacetals, copolymers of ethylene and polytetrafluoroethylene, rubber-modified polystyrenes, polyurethanes, and combinations thereof. In some embodiments, the polymer comprises a poly(arylene ether). The flame retardant mixture can be used in an amount of about 5 to about 30 weight percent, specifically about 10 to about 20 weight percent, based on the total weight of the composition. The flame retardant components can be used in a weight ratio of zinc borate:melamine cyanurate:organophosphate ester of about 1-10:5-20:2-15, wherein the individual values are weight percents based on the total weight of the composition.

The invention extends to articles extruded or molded from the composition. Thus, one embodiment is an extrusion molded article or injection molded article comprising the product of extrusion molding or injection molding any variation of the composition described herein. The composition is particularly useful for forming insulating layers on wire or cable. Thus, the article can be a coated wire comprising a conductor and a covering disposed on the conductor, wherein the covering comprises any variation of the composition described herein. The conductor can conduct light or electricity.

In some embodiments, the conductor has a normal to large cross-sectional area corresponding to American Wire Gauge (AWG) 24 to AWG 5. The thickness of the covering can be, for example, 0.25 to 8.0 millimeter. The conductor can be a single thread/strand or a bundle of several threads/strands. The conductor material can be metal (such as copper, aluminum, steel, copper alloy, aluminum alloy, copper coated aluminum, nickel and or tin coated copper) for electrical power transmission or for electronic signal transmission. The covered conductor comprises a conductor and a covering comprising the thermoplastic composition, wherein the covering is disposed over the conductor, wherein the conductor has a cross-section that meets as least one of following: (i) AWG 24 to AWG 5, (ii) a cross-section area of 0.20 to 16.8 millimeter² (corresponding to AWG 24 to AWG 5 according to ASTM B256-02); (iii) a nominal diameter of 0.51 to 4.62 millimeter (corresponding to AWG 24 to AWG 5 according to UL 1581, 4th edition, Table 20.1).

In other embodiments, the conductor is a small conductor with a thin coating. In this embodiment, the conduct has a cross-sectional area corresponding to AWG 26 to AWG 56. The thickness of the covering can be, for example, 0.010 to 0.85 millimeter. The conductor can be a single thread/strand or a bundle of several threads/strands. The conductor material can be metal (such as copper, aluminum, steel, copper alloy, copper coated aluminum, nickel and or tin coated copper) for electrical power transmission or for electronic signal transmission. In addition, the conductor material also can be glass or plastics in optical fiber application for single transmission. The conductor can have a cross-section that meets as least one of following: (i) American Wire Gauge (AWG) of AWG 56 to AWG 26, (ii) a cross-section area of 0.000122 to 0.128 millimeter² (corresponding to AWG 56 to AWG 26 according to ASTM B256-02); (iii) a nominal diameter from 0.0124 to 0.404 millimeter (corresponding to AWG 56 to AWG 26 according to UL 1581, 4th edition, Table 20.1).

The invention includes at least the following embodiments.

Embodiment 1: A composition comprising: about 21 to about 40 weight percent of a poly(arylene ether); about 20 to about 45 weight percent of a hydrogenated block copolymer of an alkenyl aromatic compound and a conjugated diene; about 2 to about 20 weight percent of a polyolefin; and about 11 to about 35 weight percent of a flame retardant comprising about 1 to about 10 weight percent of zinc borate, about 5 to about 20 weight percent of melamine cyanurate, and about 2 to about 15 weight percent of an organophosphate ester; wherein all weight percents are based on the total weight of the composition, unless a different weight basis is specified.

Embodiment 2: The composition of embodiment 1, wherein the polyolefin comprises polyisobutylene.

Embodiment 3: The composition of embodiment 1, wherein the polyolefin comprises polypropylene and polyisobutylene.

Embodiment 4: The composition of embodiment 1, wherein the polyolefin consists of polypropylene and polyisobutylene.

Embodiment 5: The composition of any of embodiments 1-4, wherein the polyolefin excludes ethylene homopolymers.

Embodiment 6: The composition of any of embodiments 1-5, further comprising about 3 to about 10 weight percent of mineral oil.

Embodiment 7: The composition of any of embodiments 1-6, wherein the organophosphate ester comprises bisphenol A bis(diphenyl phosphate).

Embodiment 8: The composition of any of embodiment 1-7, excluding boron phosphate.

Embodiment 9: The composition of any of embodiments 1-8, excluding magnesium dihydroxide.

Embodiment 10: The composition of any of embodiment 1-9, excluding phosphinate flame retardants.

Embodiment 11: The composition of any of embodiments 1-10, excluding phosphate flame retardants other than the organophosphate ester.

Embodiment 12: The composition of embodiment 1, wherein the poly(arylene ether) comprises a poly(2,6-dimethyl-1,4-phenylene ether) having an intrinsic viscosity of about 0.35 to about 0.5 deciliters per gram, measured at 25° C. in chloroform; wherein the composition comprises about 22 to about 30 weight percent of the poly(arylene ether); wherein the hydrogenated block copolymer comprises a polystyrene-poly(ethylene-butylene)-polystyrene or polystyrene-poly(ethylene-butylene-styrene)-polystyrene triblock copolymer; wherein the composition comprises about 26 to about 36 weight percent of the hydrogenated block copolymer, wherein the polyolefin comprises polypropylene and polyisobutylene; wherein the composition comprises about 11 to about 16 weight percent of the polyolefin; wherein the flame retardant comprises about 2 to about 9 weight percent of zinc borate, about 5 to about 15 weight percent of melamine cyanurate, and about 4 to about 15 weight percent of an organophosphate ester; and wherein the composition further comprises about 3 to about 10 weight percent of mineral oil.

Embodiment 13: A composition comprising the product of melt blending components comprising: about 21 to about 40 weight percent of a poly(arylene ether); about 20 to about 45 weight percent of a hydrogenated block copolymer of an alkenyl aromatic compound and a conjugated diene; about 2 to about 20 weight percent of a polyolefin; and about 11 to about 35 weight percent of a flame retardant comprising about 1 to about 10 weight percent of zinc borate, about 5 to about 20 weight percent of melamine cyanurate, and about 2 to about 15 weight percent of an organophosphate ester; wherein all weight percents are based on the total weight of the composition, unless a different weight basis is specified.

Embodiment 14: An extrusion molded article or injection molded article comprising the product of extrusion molding or injection molding the composition of embodiment 1, 12, or 13.

Embodiment 15: The extrusion molded article or injection molded article of embodiment 14, wherein the extruded article or injection molded article is a coated wire comprising a conductor, and a covering disposed on the conductor; wherein the covering comprises the composition of embodiment 1.

Embodiment 16: The extrusion molded article or injection molded article of embodiment 14, wherein the extruded article or injection molded article is a coated wire comprising a conductor, and a covering disposed on the conductor; wherein the covering comprises the composition of embodiment 12.

Embodiment 17: The extrusion molded article or injection molded article of embodiment 14, wherein the extruded article or injection molded article is a coated wire comprising a conductor, and a covering disposed on the conductor, wherein the covering comprises the composition of embodiment 13.

Embodiment 18: A composition comprising: a polymer; and a flame retardant mixture comprising zinc borate, melamine cyanurate, and an organophosphate ester.

The invention is further illustrated by the following non-limiting examples.

### Examples 1-8

### Comparative Examples 1-8

Table 1 summarizes the components used in the working examples.

TABLE 1

| Component | Description |
|---|---|
| PPE | Poly(2,6-dimethyl-1,4-phenylene ether), CAS Reg. No. 25134-01-4, |
| | having an intrinsic viscosity of 0.46 deciliter per gram measured in |
| | chloroform at 25° C. and a weight average molecular weight of 59,000 |
| | atomic mass units; obtained as PPO 646 from SABIC Innovative |
| | Plastics |
| SEBS RP6936 | Polystyrene-poly(ethylene-butylene-styrene)-polystyrene triblock |
| | copolymer, CAS Reg. No. 66070-58-4, having a polystyrene content |
| | of 39 weight percent and a weight average molecular weight of about |
| | 175,000 atomic mass units; obtained as Kraton A-RP6936 from |
| | Kraton Polymers. |
| SEBS blend | A melt-kneaded blend comprising about 35 weight percent of a |
| | mixture of polystyrene-poly(ethylene-butylene)-polystyrene triblock |
| | copolymer and polystyrene-poly(ethylene-propylene)-polystyrene |
| | triblock copolymer; about 20 weight percent of a mixture of |
| | polypropylene and ethylene propylene copolymer; about 45 weight |
| | percent mineral oil; and about 100 parts per million by weight of |
| | calcium carbonate; obtained as TPE-SB2400 from Sumitomo |
| | Chemical. |
| PP | Polypropylene (propylene homopolymer), CAS Reg. No. 9003-07-0, |
| | having a melt mass-flow rate of 8 grams per 10 minutes, measured |
| | according to ASTM D1238-10 at 230° C. and a 2.16 kilogram load; |
| | obtained as PP 570P from Sabic. |
| PIB | Polyisobutylene, CAS Reg. No. 9003-27-4, having a number average |
| | molecular weight of about 800 atomic mass units; obtained as |
| | INDOPOL H50 from BP Chemical. |
| Mg(OH)₂ | Magnesium dihydroxide, CAS Reg. No. 1309-42-8, obtained as |
| | KISUMA 5A from Kyowa Chemical. |
| ZnB | Zinc borate, CAS Reg: No. 1332-07-6, obtained as FIREBRAKE ZB |
| | from U.S. Borax Inc. |
| MPP | Melamine polyphosphate, CAS Reg. No. 56386-64-2, obtained as |
| | BUDIT 3141 from Budenheim Iberica, S.A. |
| MC | Melamine cyanurate, CAS Reg. No. 37640-57-6, obtained as |
| | JLS-MC25 from JLS Chemical. |
| BPADP | Bisphenol A bis(diphenyl phosphate), CAS Reg. No. 181028-79-5, |
| | obtained as FYROLFLEX BDP from Supresta LLC, or REOFOS |
| | BAPP from Great Lakes Chemical Co. Ltd. |
| Additives | Additives that can include one or more of the following: Erucamide |
| | (cis-13-docosenoamide), CAS Reg. No. 112-84-5, obtained as |
| | KEMAMIDE E ULTRA from Chemtura; Octadecyl 3-(3,5-di-tert- |
| | butyl-4-hydroxyphenyl)propionate, CAS Reg. No. 2082-79-3 |
| | obtained as IRGANOX 1076 from Ciba; 2′,3-bis[[3-[3,5-di-tert-butyl- |
| | 4-hydroxyphenyl]]propionyl]]propionohydrazide, CAS Reg. No. |
| | 32687-78-8 obtained as IRGANOX MD1024 from CIBA; the |
| | reaction product of 2,4-di(tert-butyl)phenol, phosphorus trichloride, |
| | and biphenyl, CAS Reg. No. 119345-01-6, obtained as SANDOSTAB |
| | P-EPQ from Clariant; and carbon black, CAS Reg. No. 1333-86-4, |
| | obtained as Monarch 800 from Cabot. |

All components were compounded on a 37 millimeter, twin-screw Toshiba TEM-37BS extruder operating at 400 rotations per minute and a throughput of approximately 30 kilograms per hour. The extruder had zone temperatures of 50° C./180° C./225° C./245° C. 245° C./245° C./245° C./245° C./245° C./245° C./245° C. (from feed throat to die), and a die temperature of 255° C.

Samples for physical property testing were injection molded using a Nissei ES3000-25E injection molding machine operating with zone temperatures of 235° C./250° C./250° C. (from feed throat to die), a nozzle temperature of 245° C., a mold temperature of 40° C.

Coated wire samples were extruded on a WTL EXL50 extruder with a melt temperature at 240° C. without pre-heating of copper conductor. The line speed was set at 70 meters/minute. The wire configuration was AWG 24 copper conductor with coating thickness of 0.74 millimeters.

Melt mass-flow rate was determined according to ASTM D1238-10 at 250° C., 5 kilogram load, and a dwell time of 300 seconds. Tensile properties were determined according to ASTM D638-10 at 23° C. using a test speed of 50 millimeters per minute. Flexural properties were determined according to ASTM D790-10 at 23° C. using a span of 100 millimeters and a test speed of 12.5 millimeters per minute. Shore A hardness (durometer hardness) was determined according to ASTM D2240-05 (2010) at 23° C. using two overlapping color chips to yield an overall thickness of 6.4 millimeters; hardness data was read at 30 seconds. Flame retardancy of injection molded flame bars was determined according to Underwriter's Laboratory Bulletin 94 “Tests for Flammability of Plastic Materials, UL 94”, 20 mm Vertical Burning Flame Test, with flame bars conditioned at 23° C. and 50% relative humidity for at least 48 hours before testing. Wire covering tensile properties were determined according to Underwriter's Laboratory Bulletin 1581 “Reference Standard for Electrical Wires, Cables, and Flexible Cords, UL 1581”, Section 470, at 23° C. using a space between benchmarks of 25 millimeters and a test speed of 500 millimeters per minute; aging was conducted in an oven at 113° C. for 168 hours. Wire heat deformation was determined according to Underwriter's Laboratory Bulletin 1581 “Reference Standard for Electrical Wires, Cables, and Flexible Cords, UL 1581”, Section 560, at 100° C. for 1 hour with a 250 gram loading. Wire flame out times “VW-1, 2C/FOT (sec)” and “VW-1, 1C/FOT (sec)” were determined according to Underwriter's Laboratory Bulletin 1581 “Reference Standard for Electrical Wires, Cables, and Flexible Cords, UL 1581”, Section 1080 (VW-1 Vertical Specimen), with “2C” corresponding to two coated wires fixed together side by side, and “1C” corresponding to a single coated wire.

Compositions and properties are summarized in Table 2-4. All component amounts are expressed in parts by weight.

In Table 3, Comparative Example 1 is representative of prior art compositions using a combination of melamine polyphosphate (a relatively expensive flame retardant), magnesium dihydroxide, and an organophosphate ester. The composition achieved a UL 94 V-1 rating at the larger thickness of 6.4 millimeters and passed the VW-1 1C test. In Comparative Example 2, the magnesium dihydroxide was replaced with an equal loading of zinc borate. This composition failed all UL94 and VW-1 tests, indicating a deterioration of flame retardancy relative to Comparative Example 1. In the Example 1 composition, the melamine polyphosphate in the Comparative Example 2 composition was replaced with an equal loading of melamine cyanurate. The Example 1 composition still failed the UL 94 tests but passed the VW-1, 1C test with a flame out time similar to that of Comparative Example 1. Most mechanical and heat-resistance resistant properties of Comparative Example 1 and Example 1 composition were similar, except for Shore A hardness and flexural modulus, which were desirably lower for the Example 1 composition. It was unexpected to find that the use of zinc borate in the Example 1 was associated with substantially increased flexibility (manifested as reduced Shore A hardness and reduced flexural modulus) relative to the use of magnesium hydroxide in Comparative Example 1: The replacement of the melamine polyphosphate/magnesium dihydroxide/organophosphate ester flame retardant package of Comparative Example 1 with the melamine cyanurate/zinc borate/organophosphate ester flame retardant package of Example 1 also substantially reduced the total cost of the composition. It is important to note that the Example 1 composition's failure to pass the UL 94 flame retardancy test is not necessarily an impediment to commercial adoption, because passing UL 94 is typically not required (whereas passing VW-1, 1C typically is required).

TABLE 2

| | C. | C. | |
|---|---|---|---|
| | Ex. 1 | Ex. 2 | Ex. 1 |
| COMPOSITIONS | | | |
| PPE | 23 | 23 | 23 |
| SEBS RP6936 | 29 | 29 | 29 |
| SEBS blend | 17 | 17 | 17 |
| PP | 2 | 2 | 2 |
| PIB | 8 | 8 | 8 |
| Mg(OH)₂ | 4 | 0 | 0 |
| ZnB | 0 | 4 | 4 |
| MPP | 7 | 7 | 0 |
| MC | 0 | 0 | 7 |
| BPADP | 10 | 10 | 10 |
| Additives | 2.3 | 2.3 | 2.3 |
| PROPERTIES | | | |
| MFR, 250° C., 5 kg | 12.0 | 11.7 | 11.3 |
| (g/10 min) | | | |
| Flexural Modulus (MPa) | 55.8 | 31.1 | 34.1 |
| Shore A Hardness | 77.4 | 74 | 74.6 |
| Tensile Strength at | 16.1 | 16.0 | 16.2 |
| Break (MPa) | | | |
| Tensile Elongation at | 217 | 231 | 230 |
| Break (%) | | | |
| UL 94 rating at 6.4 mm | V-1 | failed | failed |
| UL 94 rating at 3.2 mm | failed | failed | failed |
| Wire Tensile Strength | 20.5 | 20.0 | 21.4 |
| at Break (MPa) | | | |
| Wire Tensile Elongation | 290 | 276 | 296 |
| at Break (%) | | | |
| Post-aging Wire Tensile | 24.3 | 22.3 | 24.5 |
| Strength at Break (MPa) | | | |
| Post-aging Wire Tensile | 248 | 245 | 262 |
| Elongation at Break (%) | | | |
| Tensile Strength | 119% | 112% | 114% |
| Retention after | | | |
| Aging (%) | | | |
| Tensile Elongation | 85% | 89% | 89% |
| Retention after | | | |
| Aging (%) | | | |
| Heat Deformation (%) | 19.0 | 19.8 | 19.3 |
| VW-1, 1C (sec) | 16.7 | failed | 14.3 |
| VW-1, 2C (sec) | failed | failed | failed |

Compositions and corresponding properties as a function of poly(arylene ether) and flame retardant content are summarized in Table 4. The Comparative Example 3 composition utilizes a melamine polyphosphate/magnesium dihydroxide/organophosphate ester flame retardant package and exhibited a UL 94 V-0 rating at 6.4 millimeters, a V-1 rating at 3.2 millimeters, and passed the VW-1, 1C and 2C tests. The Example 2 composition replaces the melamine polyphosphate and magnesium dihydroxide of Comparative Example 3 with melamine cyanurate and zinc borate, respectively. Although the Example 2 composition failed to achieve a V-0 or V-1 rating at either thickness, it passed the VW-1, 1C and 2C tests. Most mechanical and heat resistant properties of the Comparative Example 3 and Example 2 compositions are similar, except that the Example 2 composition exhibits improved flexibility as evidenced by lower Shore A hardness and flexural modulus values.

Poly(arylene ether) loading has a significant effect on the flame retardancy of the inventive compositions with a melamine cyanurate/zinc borate/organophosphate ester flame retardant package. Comparative Example 4 contains such a flame retardant package but has a reduced poly(arylene ether) content of 20 parts by weight. The Comparative Example 4 composition failed the VW-1 tests, whereas Example 2 with 25 parts by weight poly(arylene ether) passed the VW-1 tests. Further demonstrating the importance of poly(arylene ether) content, the Example 3 composition with 30 parts by weight poly(arylene ether) not only passed the VW-1 tests (with reduced flame out times relative to Example 2) but also achieved a UL 94 V-1 rating at both 6.4 and 3.2 millimeters.

The Example 4-8 compositions were designed to study the effect of flame retardant loading. In the Example 4 composition, the zinc borate loading was decreased to 1 part by weight, but the composition still passed the VW-1, 1C and 2C tests. It is also unexpected that the Example 4 composition achieved a UL 94 V-1 rating at 6.4 millimeters. Even more unexpectedly, the 1 part by weight zinc borate in Example 4 was enough to remarkably lower the Shore A hardness and flexural modulus relative to Comparative Example 5. When the zinc borate loading was increased to 10 parts by weight in Example 5, the composition passed the VW-1, 1C test but failed the VW-1, 2C test. This shows that too high a loading of zinc borate can have a negative effect on flame retardancy. For the Example 6 and 7 compositions, the melamine cyanurate and organophosphate ester loadings, respectively, were increased by 5 parts by weight. Both of these compositions achieved a UL 94 V-1 rating at 6.4 millimeters and passed the VW-1 tests. However, the Shore A hardness and flexural modulus of the Example 7 composition increased. The effect of organophosphate ester type is illustrated by a comparison of the Example 2 composition (with BPADP) and the Example 8 composition (with RDP). Although RDP typically provides better flame retardancy than BPADP at the same loading (due to RDP's higher phosphorous content), use of BPADP was associated with superior flame retardancy in this system, as evidenced by the BPADP-containing Example 2 composition passing the VW-1, 2C test that was failed by the RDP-containing Example 8 composition.

TABLE 3

| | C. | | C. | | |
|---|---|---|---|---|---|
| | Ex. 3 | Ex. 2 | Ex. 4 | Ex. 3 | Ex. 4 |
| COMPOSITIONS | | | | | |
| PPE | 25 | 25 | 20 | 30 | 25 |
| SEBS RP6936 | 25 | 25 | 25 | 25 | 25 |
| SEBS blend | 15 | 15 | 15 | 15 | 15 |
| PP | 3 | 3 | 3 | 3 | 3 |
| PIB | 7 | 7 | 7 | 7 | 7 |
| Mg(OH)₂ | 5 | 0 | 0 | 0 | 0 |
| ZnB | 0 | 5 | 5 | 5 | 1 |
| MPP | 10 | 0 | 0 | 0 | 0 |
| MC | 0 | 10 | 10 | 10 | 10 |
| BPADP | 10 | 10 | 10 | 10 | 10 |
| RDP | 0 | 0 | 0 | 0 | 0 |
| Additives | 2.5 | 2.5 | 2.5 | 2.5 | 2.5 |
| PROPERTIES | | | | | |
| MFR, 250° C., 5 kg | 11.6 | 9.2 | 10.4 | 7.3 | 8.8 |
| (g/10 min) | | | | | |
| Flexural Modulus (MPa) | 91.5 | 60.9 | 46 | 77.3 | 64.9 |
| Shore A Hardness | 84.5 | 82 | 78.6 | 85.4 | 82.3 |
| Tensile Strength at | 16.9 | 15.4 | 14.0 | 14.5 | 15.8 |
| Break (MPa) | | | | | |
| Tensile Elongation | 179 | 175 | 214 | 133 | 178 |
| at Break (%) | | | | | |
| UL 94 rating at 6.4 mm | V-0 | failed | failed | V-1 | V-1 |
| UL 94 rating at 3.2 mm | V-1 | failed | failed | V-1 | failed |
| Wire Tensile Strength | 21.0 | 21.5 | 20.0 | 22.1 | 22.2 |
| at Break (MPa) | | | | | |
| Wire Tensile Elongation | 250 | 256 | 323 | 232 | 270 |
| at Break (%) | | | | | |
| Post-aging Wire Tensile | 22.7 | 24.1 | 21.9 | 24.3 | 25.7 |
| Strength at Break (MPa) | | | | | |
| Post-aging Wire Tensile | 210 | 215 | 252 | 182 | 236 |
| Elongation at Break (%) | | | | | |
| Tensile Strength | 108 | 112 | 110 | 110 | 116 |
| Retention after | | | | | |
| Aging (%) | | | | | |
| Tensile Elongation | 84 | 84 | 78 | 78 | 87 |
| Retention after | | | | | |
| Aging (%) | | | | | |
| Heat Deformation (%) | 16.1 | 14.5 | 21.1 | 7.8 | 12.8 |
| VW-1, 1C (sec) | 12.3 | 18.3 | failed | 12.7 | 20.7 |
| VW-1, 2C (sec) | 37.3 | 36.7 | failed | 34.7 | 32.7 |

| | Ex. 5 | Ex. 6 | Ex. 7 | Ex. 8 |
|---|---|---|---|---|
| COMPOSITIONS | | | | |
| PPE | 25 | 25 | 25 | 25 |
| SEBS RP6936 | 25 | 25 | 25 | 25 |
| SEBS blend | 15 | 15 | 15 | 15 |
| PP | 3 | 3 | 3 | 3 |
| PIB | 7 | 7 | 7 | 7 |
| Mg(OH)₂ | 0 | 0 | 0 | 0 |
| ZnB | 10 | 5 | 5 | 5 |
| MPP | 0 | 0 | 0 | 0 |
| MC | 10 | 15 | 10 | 10 |
| BPADP | 10 | 10 | 15 | 0 |
| RDP | 0 | 0 | 0 | 10 |
| Additives | 2.5 | 2.5 | 2.5 | 2.5 |
| PROPERTIES | | | | |
| MFR, 250° C., 5 kg | 7.3 | 6.9 | 13.6 | 7.0 |
| (g/10 min) | | | | |
| Flexural Modulus (MPa) | 57 | 53 | 151 | 54 |
| Shore A Hardness | 81.4 | 82.3 | 88.1 | 81.7 |
| Tensile Strength at | 14.2 | 14.4 | 16.9 | 12.3 |
| Break (MPa) | | | | |
| Tensile Elongation | 161 | 162 | 158 | 176 |
| at Break (%) | | | | |
| UL 94 rating at 6.4 mm | failed | V-1 | V-1 | failed |
| UL 94 rating at 3.2 mm | failed | failed | failed | failed |
| Wire Tensile Strength | 19.3 | 20.0 | 20.5 | 21.6 |
| at Break (MPa) | | | | |
| Wire Tensile Elongation | 260 | 265 | 259 | 267 |
| at Break (%) | | | | |
| Post-aging Wire Tensile | 22.1 | 23.0 | 22.3 | 24.0 |
| Strength at Break (MPa) | | | | |
| Post-aging Wire Tensile | 202 | 211 | 201 | 239 |
| Elongation at Break (%) | | | | |
| Tensile Strength | 115 | 115 | 109 | 111 |
| Retention after | | | | |
| Aging (%) | | | | |
| Tensile Elongation | 78 | 79 | 78 | 89 |
| Retention after | | | | |
| Aging (%) | | | | |
| Heat Deformation (%) | 12.4 | 12.0 | 20.8 | 15.4 |
| VW-1, 1C (sec) | 19.3 | 17.7 | 12 | 17.3 |
| VW-1, 2C (sec) | failed | 43.7 | 37.7 | failed |

Table 4 summarizes compositions and properties for three comparative examples containing melamine cyanurate and organophosphate ester but lacking zinc borate. The Comparative Example 5 composition differs from the Example 4 composition in that the former lacks zinc borate and the latter contains 1 part by weight zinc borate. However, the Comparative Example 5 composition without zinc borate fails the VW-1, 1C test, while the Example 4 composition passes that test. Moreover, the Comparative Example 5 composition is less flexible than the Example 4 composition with just 1 part by weight zinc borate, as indicated by Shore A hardness and flexural modulus. Thus, zinc borate has a remarkable and unexpected softening effect at loadings as low as 1 part by weight. Starting with the Comparative Example 5 composition and increasing the melamine cyanurate loading from 10 to 15 parts by weight yields the Comparative Example 6 composition, which passes the VW-1, 1C test. Starting with the Comparative Example 0.5 composition and increasing the organophosphate ester loading from 10 to 15 parts by weight yields the Comparative Example 7 composition, which still does not pass the VW-1, 1C test.

TABLE 4

| | C. | C. | C. |
|---|---|---|---|
| | Ex. 5 | Ex. 6 | Ex. 7 |
| COMPOSITIONS | | | |
| PPE | 25 | 25 | 25 |
| SEBS RP6936 | 25 | 25 | 25 |
| SEBS blend | 15 | 15 | 15 |
| PP | 3 | 3 | 3 |
| PIB | 7 | 7 | 7 |
| ZnB | 0 | 0 | 0 |
| MC | 10 | 15 | 10 |
| BPADP | 10 | 10 | 15 |
| Additives | 2.5 | 2.5 | 2.5 |
| PROPERTIES | | | |
| MFR, 250° C., 5 kg | 10.2 | 7.1 | 14.4 |
| (g/10 min) | | | |
| Flexural Modulus (MPa) | 156 | 118 | 303 |
| Shore A Hardness | 85.7 | 85.2 | 89.9 |
| Tensile Strength at | 15.8 | 17.0 | 17.3 |
| Break (MPa) | | | |
| Tensile Elongation at | 172 | 163 | 159 |
| Break (%) | | | |
| UL 94 rating at 6.4 mm | failed | failed | failed |
| UL 94 rating at 3.2 mm | failed | failed | failed |
| Wire Tensile Strength | 21.2 | 20.3 | 20.9 |
| at Break (MPa) | | | |
| Wire Tensile Elongation | 259 | 257 | 265 |
| at Break (%) | | | |
| Post-aging Wire Tensile | 23.9 | 22.5 | 22.4 |
| Strength at Break (MPa) | | | |
| Post-aging Wire Tensile | 212 | 206 | 216 |
| Elongation at Break (%) | | | |
| Tensile Strength | 113 | 111 | 107 |
| Retention after | | | |
| Aging (%) | | | |
| Tensile Elongation | 82 | 80 | 82 |
| Retention after | | | |
| Aging (%) | | | |
| Heat Deformation (%) | 14.6 | 11.9 | 21.6 |
| VW-1, 1C (sec) | failed | 16.2 | failed |
| VW-1, 2C (sec) | 34 | 32 | 34.3 |

In Table 5, relevant portions of Example 25 from U.S. Pat. No. 7,622,522 B2 to Qiu. et al. are reproduced as Comparative Example 8 of this application. Comparative Example 8 is intended to illustrate the properties obtained with a flame retardant comprising melamine polyphosphate (an expensive flame retardant), aluminum tris(diethyl phosphinate) (another expensive flame retardant), and bisphenol A bis(diphenyl phosphate). In Table 5, the component designations of this application have been used where appropriate to facilitate comparison. In Table 5, “SEBS II” is a polystyrene-poly(ethylene/butylene)-polystyrene triblock copolymer having a polystyrene content of 30%; obtained as Kraton G1650 from Kraton Polymers Ltd.; “DEPAL” is aluminum tris(diethyl phosphinate), CAS Reg. No. 225789-38-8; obtained as OP 930 or OP 1230 from Clariant. Rigorous comparisons to the present inventive examples are not possible, but it is notable that the Comparative Example 8 composition failed the UL 94 vertical burning test and passed the UL 1581 VW-1 flammability test. It is also notable that the Comparative Example 8 composition is less flexible (as evidenced by Shore A harness and flexural modulus values) than seven of the eight present inventive Examples (the exception being Example 7). This illustrates that, compared to relatively more expensive compositions containing melamine polyphosphate and aluminum tris(diethyl phosphinate), the present compositions can exhibit comparable flame retardancy and improved flexibility at reduced cost.

TABLE 5

| | C. |
|---|---|
| | Ex. 8 |
| COMPOSITION | |
| PPE | 34.0 |
| PP | 8.0 |
| SEBS blend | 8.0 |
| PIB | 5.0 |
| SEBS RP6936 | 28.0 |
| SEBS II | 4.0 |
| MPP | 4.0 |
| DEPAL | 4.0 |
| BPADP | 5.0 |
| PROPERTIES | |
| Flexural Modulus (MPa) | 103.0 |
| Shore A Hardness | 87.9 |
| Tensile Strength at | 20.3 |
| Break (MPa) | |
| Tensile Elongation | 155.5 |
| at Break (%) | |
| UL 94 rating at 6.4 mm | failed |
| UL 94 rating at 3.2 mm | failed |
| Wire Tensile Strength | 25.4 |
| at Break (MPa) | |
| Wire Tensile Elongation | 192 |
| at Break (%) | |
| Heat Deformation (%) | 9.4 |
| UL 1581 VW-1 rating | passed |

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other. Each range disclosed herein constitutes a disclosure of any point or sub-range lying within the disclosed range.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

1. A composition comprising:
about 21 to about 40 weight percent of a poly(arylene ether);
about 20 to about 45 weight percent of a hydrogenated block copolymer of an alkenyl aromatic compound and a conjugated diene;
about 2 to about 20 weight percent of a polyolefin; and
about 11 to about 35 weight percent of a flame retardant comprising
about 1 to about 10 weight percent of zinc borate,
about 5 to about 20 weight percent of melamine cyanurate, and
about 2 to about 15 weight percent of an organophosphate ester;
wherein all weight percents are based on the total weight of the composition, unless a different weight basis is specified.

2. The composition of claim 1, wherein the polyolefin comprises polyisobutylene.

3. The composition of claim 1, wherein the polyolefin comprises polypropylene and polyisobutylene.

4. The composition of claim 1, wherein the polyolefin consists of polypropylene and polyisobutylene.

5. The composition of claim 1, wherein the polyolefin excludes ethylene homopolymers.

6. The composition of claim 1, further comprising about 3 to about 10 weight percent of mineral oil.

7. The composition of any of claims 1-6, wherein the organophosphate ester comprises bisphenol A bis(diphenyl phosphate).

8. The composition of any of claims 1-6, excluding boron phosphate.

9. The composition of any of claims 1-6, excluding magnesium dihydroxide.

10. The composition of any of claims 1-6, excluding phosphinate flame retardants.

11. The composition of any of claims 1-6, excluding phosphate flame retardants other than the organophosphate ester.

12. The composition of claim 1,
wherein the poly(arylene ether) comprises a poly(2,6-dimethyl-1,4-phenylene ether) having an intrinsic viscosity of about 0.35 to about 0.5 deciliters per gram, measured at 25° C. in chloroform;
wherein the composition comprises about 22 to about 30 weight percent of the poly(arylene ether);
wherein the hydrogenated block copolymer comprises a polystyrene-poly(ethylene-butylene)-polystyrene or polystyrene-poly(ethylene-butyl-styrene)-polystyrene triblock copolymer;
wherein the composition comprises about 26 to about 36 weight percent of the hydrogenated block copolymer,
wherein the polyolefin comprises polypropylene and polyisobutylene;
wherein the composition comprises about 11 to about 16 weight percent of the polyolefin;
wherein the flame retardant comprises
about 2 to about 9 weight percent of zinc borate,
about 5 to about 15 weight percent of melamine cyanurate, and
about 4 to about 15 weight percent of an organophosphate ester; and
wherein the composition further comprises about 3 to about 10 weight percent of mineral oil.

13. A composition comprising the product of melt blending components comprising:
about 21 to about 40 weight percent of a poly(arylene ether);
about 20 to about 45 weight percent of a hydrogenated block copolymer of an alkenyl aromatic compound and a conjugated diene;
about 2 to about 20 weight percent of a polyolefin; and
about 11 to about 35 weight percent of a flame retardant comprising
about 1 to about 10 weight percent of zinc borate,
about 5 to about 20 weight percent of melamine cyanurate, and
about 2 to about 15 weight percent of an organophosphate ester,
wherein all weight percents are based on the total weight of the composition, unless a different weight basis is specified.

14. An extrusion molded article or injection molded article comprising the product of extrusion molding or injection molding the composition of claim 1, 12, or 13.

15. The extrusion molded article or injection molded article of claim 14, wherein the extruded article or injection molded article is a coated wire comprising a conductor, and a covering disposed on the conductor, wherein the covering comprises the composition of claim 1.

16. The extrusion molded article or injection molded article of claim 14, wherein the extruded article or injection molded article is a coated wire comprising a conductor, and a covering disposed on the conductor, wherein the covering comprises the composition of claim 12.

17. The extrusion molded article or injection molded article of claim 14, wherein the extruded article or injection molded article is a coated wire comprising a conductor, and a covering disposed on the conductor; wherein the covering comprises the composition of claim 13.

18. A composition comprising:
a polymer; and
a flame retardant mixture comprising
zinc borate,
melamine cyanurate, and
an organophosphate ester.
